(19) United States
(12) Patent Application Publication
(10) Pub. No.: US 2010/0134409 A1
(43) Pub. Date: Jun. 3, 2010

(54) THREE-DIMENSIONAL USER INTERFACE

(75) Inventors: David C. Challener, Raleigh, NC (US); James S. Rutledge, Durham, NC (US); Jinping Yang, Beijing (CN)

Correspondence Address: FERENCE & ASSOCIATES LLC, 409 BROAD STREET, PITTSBURGH, PA, 15143, US

(73) Assignee: Lenovo (Singapore) Pte. Ltd., Singapore (SG)

(21) Appl. No.: 12/325,255

(22) Filed: Nov. 30, 2008

(51) Int. Cl. G09G 5/00

(52) U.S. Cl. 345/156

(57) ABSTRACT

The instant invention provides an apparatus, method and program storage device enabling a three-dimensional user interface for the movement of objects rendered upon a display device in a more realistic and intuitive manner. A Z distance is set whereupon a user crossing the Z distance is enabled to select an object, i.e. pick it up. As the user breaks the Z distance again, the object selected will move with the user's hand. As the user breaks the Z distance once more, the object will be released, i.e. dropped into a new position.

### FIELD OF THE INVENTION

The present invention relates to multi-dimensional user interfaces for electronic devices.

### BACKGROUND OF THE INVENTION

Conventional arrangements for moving objects around a display screen of an electronic device (e.g. a laptop personal computer (PC)) rely upon mouse clicks, wherein the user drags the object from place to place upon the screen. Progress is being made in 3D mapping of a user's hand motions with respect to a display of an electronic device. It is now possible to use such motions as a user interface for an electronic device.

Conventional touch screens are based upon resistive or capacitive technologies. Resistive touch screens overlay a screen (e.g. Liquid Crystal Display (LCD)) with thin layers of material. The bottom layer transmits a small electrical current along an X, Y path. Sensors track voltage streams, sensing disruption. When a flexible layer is pressed (by a user), the two layers connect to form a new circuit. Sensors measure the change in voltage, ascertaining the position (X, Y coordinates). Resistive touch screens work with any kind of input, e.g. a stylus or finger.

Capacitive screens have an electrical layer at the display. A small current is run and measured within this layer. Upon a user touching the screen, an ascertainable amount of the current is taken away. Sensors measure reduction in current and triangulate the point where the user made contact (X, Y coordinates).

Infrared (IR) and Infrared Imaging touch screens utilize disruption of IR light. Infrared touch screens utilize sensors and receivers to form a grid over a display (corresponding to X, Y coordinates). A plane of IR light is provided over the display. Broken light is captured as X, Y coordinates by the sensors and receivers upon the screen and used to calculate the X, Y coordinates of interruption of the plane of laser light.

Infrared Imaging touch screens use embedded cameras to monitor the surface of the display with IR light provided thereon. IR light is transmitted away from the cameras and over the display. If the IR light is interrupted (e.g. by a user's fingertip or stylus), a camera locates the disruption.

However, all the above touch screen technologies have not been capable of accurately representing how a user actually picks up and moves “real” (i.e. physical) objects. Accordingly, a need has arisen to provide a user interface that allows increased functionality and is intuitive for the user, i.e. mimics the way users move physical objects.

### SUMMARY OF THE INVENTION

The instant invention provides an apparatus, method and program storage device enabling a three-dimensional user interface for the movement of objects rendered upon a display device in a more realistic and intuitive manner. A Z distance is set (corresponding to a distance above a surface a plane of IR light appears) whereupon a user crossing the Z distance is enabled to select an object, i.e. pick it up. As the user breaks the Z distance again, the object selected will move with the user's hand, which is being tacked by one or more cameras. As the user breaks the Z distance once more, the object will be released, i.e. dropped into a new position. Therefore, the instant invention provides a user interface that mimics the way a person actually moves physical objects. The instant invention provides a user interface that is better than conventional user interfaces for at least the reasons that the user interface does not require any physical device (e.g. a mouse) and it more closely resembles the way that users actually move physical objects.

In summary, one aspect of the invention provides an apparatus comprising: a user interface comprising: at least one infrared light generating module; and at least one camera that provides inputs upon detecting interruptions of the infrared light; at least one processor; at least one display medium; and a memory, wherein the memory stores instructions executable by the at least one processor, the instructions comprising: instructions for selecting an object rendered upon the at least one display medium in response to a first input from the at least one camera; instructions for permitting movement of the selected object in response to a second input from the at least one camera; and instructions for placing the selected object into a new position in response to a third input from the at least one camera.

Furthermore, an additional aspect of the invention provides a method comprising: generating a plane of infrared light about a user interface; providing inputs upon detecting interruptions of the plane of laser light with at least one camera; selecting an object rendered upon at least one display medium in response to a first input from the at least one camera; permitting movement of the selected object in response to a second input from the at least one camera; and placing the selected object into a new position in response to a third input from the at least one camera.

A further aspect of the present invention provides a program storage device readable by machine, tangibly embodying a program of instructions executable by the machine to perform a method, the method comprising: generating a plane of infrared light about a user interface; providing inputs upon detecting interruptions of the plane of laser light with at least one camera; selecting an object rendered upon at least one display medium in response to a first input from the at least one camera; permitting movement of the selected object in response to a second input from the at least one camera; and placing the selected object into a new position in response to a third input from the at least one camera.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a block diagram of a computing device.

FIG. 2 is s block diagram of a laptop computer suitable for use with the inventive system.

FIG. 3 is a block diagram of a virtual touch user interface according to an embodiment of the inventive system.

FIG. 4 is a flow chart summarizing the steps for selecting and moving an object upon a display of an electronic device utilizing the virtual touch user interface of the inventive system.

FIG. 5 is a block diagram of a computing device according to one embodiment of the invention.

### DETAILED DESCRIPTION OF THE PREFERRED EMBODIMENTS

For a better understanding of the present invention, together with other and further features and advantages thereof, reference is made to the following description, taken in conjunction with the accompanying drawings, and the scope of the invention will be pointed out in the appended claims.

It will be readily understood that the components of the present invention, as generally described and illustrated in the figures herein, may be arranged and designed in a wide variety of different configurations other than the described presently preferred embodiments. Thus, the following more detailed description of the embodiments of the apparatus and method of the present invention, as represented in the figures, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided, to give a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals or other labels throughout. The following description is intended only by way of example, and simply illustrates certain selected presently preferred embodiments of devices, systems, processes, etc. that are consistent with the invention as claimed herein.

The following description begins with a general description of the solutions provided by the instant invention. The description will then turn to a more detailed description of preferred embodiments of the instant invention with reference to the accompanying drawings.

In the past, a way that objects were moved about a display was by having a user click a mouse button down on the object and move the mouse across the screen, while continuing to depress the mouse button, and releasing the mouse button to drop the object into the new position. This conventional approach has an obvious drawback in that it is non-intuitive and not very natural with respect to the way in which “real” or physical objects (e.g. a stone) are picked up and manipulated in order to move them with a hand. In other words, with a stone, a user puts his or her hand down over the stone and lifts his or her hand up in order to move the stone down to some other location, thereafter dropping it.

Existing touch screen technology has recently been improved upon by utilizing screens/surfaces coupled with IR (Infrared) cameras to allow for easier operation via a “virtual touch screen”. Some useful background information on this base concept is provided in co-pending and commonly assigned U.S. patent application Ser. No. 12/251,939, filed on Oct. 15, 2008, and which is herein incorporated by reference as if fully set forth herein.

Accordingly, with this virtual touch screen, a user is enabled to accomplish touch screen functions (e.g. entering an ATM pin) without using capacitive/resistive sensors. Laser light is provided just above the keyboard or display screen to spray (provide) a plane of laser (e.g. IR) light about a quarter of an inch above the keyboard or the display itself.

Along with the provision of a plane of laser light, there is also provided at least one IR sensitive camera (e.g. one in each of the upper right and the upper left corners of the screen housing). The lasers spray an IR plane of light across the screen, hovering over the screen, and the cameras (roughly co-located with the IR light source) look across the screen. With an IR camera that measures distance based on the intensity of a reflection, mapping of a user's hand interactions with the plane of laser light is accomplished. Normally, the cameras do not detect/sense anything because there is nothing to reflect the laser light of the plane. However, if a user breaks the plane of laser light (e.g. by placing one or two fingers near the screen), the camera(s) detects that the plane of laser light is broken or interrupted.

The cameras can detect that the user has broken the beam/plane of laser light by measuring finger reflection directly. It should be noted that the finger is tracked directly by the camera and the camera does not track the rim reflection shape blocked by the finger. Thus, there is no need for a reflective rim around the screen. The cameras detect that the user has broken the beam of IR light and provide data (regarding an angle utilized to calculate where the beam was broken, e.g. where upon the screen the user has touched). Using that data, the virtual touch screen system can distinguish two fingers placed near the screen or touching the screen (i.e. locate X, Y coordinates for two separate fingers simultaneously placed near the screen).

This type of virtual touch screen is well adapted for conducting normal multi-touch activities (e.g. expanding and minimizing pictures, etc.). For example, if a user takes two fingers and moves them out from the display, the picture (displayed on the screen) enlarges. If a user takes the two fingers and moves them in, then the picture gets smaller. There are a number of software packages that are enabled to support multi-touch functionality; for example MICROSOFT WINDOWS 7 has multi-touch compatible software embedded in it to handle such multi-touch inputs.

According to one embodiment of the instant invention, there is provided a more intuitive and realistic user interface for moving objects about a display medium (e.g. liquid crystal display (LCD) screen) utilizing a virtual touch screen. According to one embodiment of the instant invention, a Z distance (corresponding to the level of the plane of IR light) is set above an area of a user interface (e.g. LCD screen or any suitable surface such as a keyboard). When a user crosses this distance (e.g. with their fingertip) in relation to the screen of an electronic device, the system ascertains an interruption in the IR light and that the user is selecting an object to move it about the display screen. As the user breaks the Z distance barrier again (for a second time), the object the user has selected will move with his or her hand in relation to the screen. As the user breaks the Z distance once more, the object will be released (i.e. “dropped”) into the new position upon the display screen.

According to one embodiment of the instant invention, the user interface thus mimics the way a user moves physical objects and is better than a traditional mouse arrangement (a currently utilized means for selecting and moving objects upon a display screen) for at least two reasons. First, the inventive system's user interface does not require any physical mouse type device. Second, the inventive system's user interface more closely resembles the way people move things about in real life.

According to an embodiment of the instant invention, when a user breaks the plane of the laser light (e.g. with fingers or a stylus), a very accurate X-Y coordinate location of where the user is touching may be calculated using the IR sensing cameras to measure finger (or stylus, etc.) reflection. Upon a particular pattern of breaking and re-entering the plane of laser light (described above), the user is enabled to “pick up” (e.g. select) objects and move them about the screen into new locations, thereafter “dropping” them.

An additional camera may be placed about the screen (e.g. on top) for determining and tracking gross movements of the user's body part (e.g. a finger). For example, if the user places his or her finger into and out of the plane, the X-Y location is calculated via data received from the IR cameras upon each plane break, but where the finger is moving in general about the screen (when not within the IR light plane) can also be calculated approximately with the additional camera. This calculation is nearly as good but not as accurate as the IR plane sensing camera coordinate calculation. However, this is immaterial because the system is using this data input for gross movement of the object across the screen when the user's hand is not within the plane of IR light. When a user moves his or hand/finger tip back in towards the screen, he or she breaks the laser light plane again, which will be sensed by the IR cameras and considered to be a dropping of the object into that new location.

According to an embodiment of the instant invention, upon a user breaking the plane, two events take place. First, the system obtains an accurate X, Y coordinate location of where the user (e.g. user's fingertip or stylus) is breaking the plane. Second, the system picks up or drops the object on the location of the screen (depending upon the pattern associated with the breaking of the plane). Essentially, the system enables a user to select the object to be moved by pointing at/touching the object (selecting it via breaking the Z distance), move the object (by breaking the Z distance again and tracked by the additional camera) to a new location where it is dropped (by again breaking the Z distance). That is, the system enables a very intuitive movement sequence approximating the way “real” or physical objects are moved.

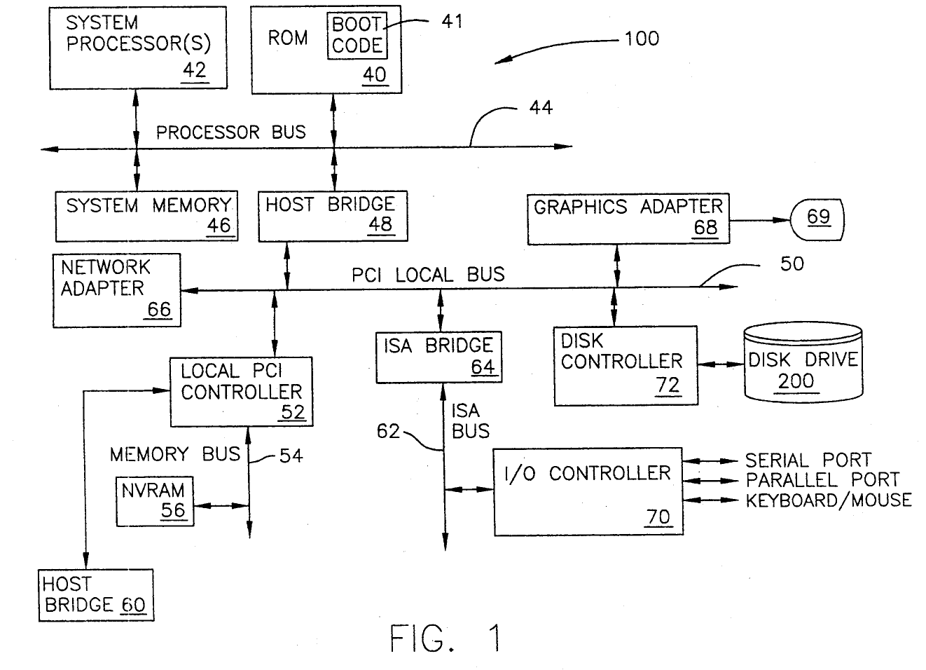

Referring now to FIG. 1, there is depicted a block diagram of an illustrative embodiment of a computer system 100. The illustrative embodiment depicted in FIG. 1 may be a notebook computer system, such as one of the ThinkPad® series of personal computers sold by Lenovo (US) Inc. of Purchase, N. Y. or a workstation computer, such as the Intellistation®, which are sold by International Business Machines (IBM) Corporation of Armonk, N.Y.; however, as will become apparent from the following description, the present invention is applicable to operation by any data processing system.

As shown in FIG. 1, computer system 100 includes at least one system processor 42, which is coupled to a Read-Only Memory (ROM) 40 and a system memory 46 by a processor bus 44. System processor 42, which may comprise one of the processors produced by Intel Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 12 to LAN 10, and graphics adapter 68, which interfaces computer system 12 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 12 and attached peripheral devices such as a keyboard, mouse, and a disk drive. In addition, I/O controller 70 supports external communication by computer system 12 via serial and parallel ports.

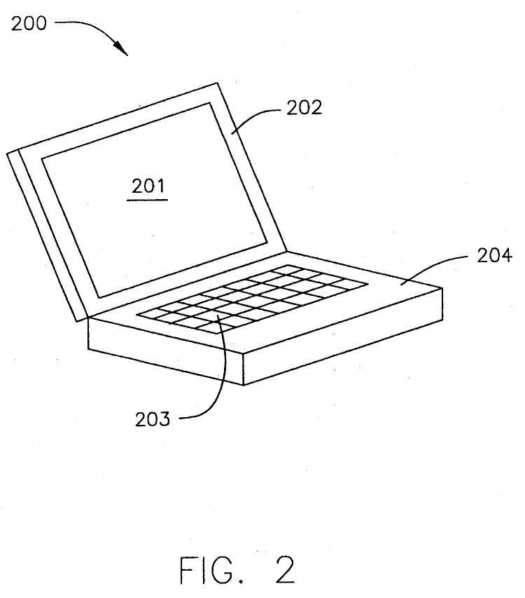

FIG. 2 represents an electronic device (200) that may be used in conjunction with the inventive system. The device (200) may be a PC essentially as described in FIG. 1 but may also be any electronic device suitable for use with the inventive system. The electronic device includes a display screen (201) surrounded by a display case (202). The display (201) and display case (202) are connected to a system case (204) that contains, for example, a keyboard (203).

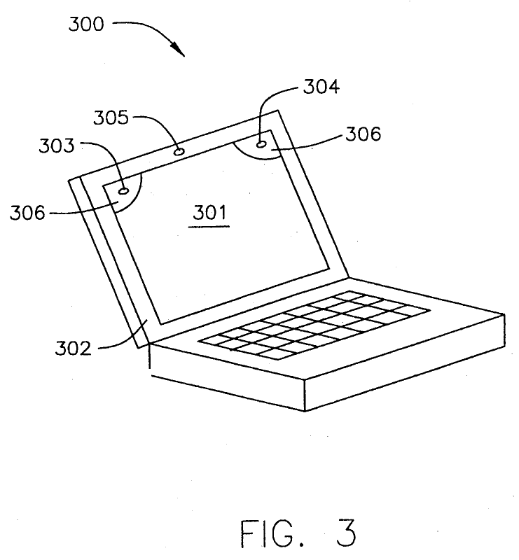

FIG. 3 represents a device (300) having a virtual touch interface according to an embodiment of the instant invention. An enlarged view of the display case (302) having a display screen (301) therein is shown. Laser light plane generating module(s) (306) are provided to spray laser light above the display screen (301). Camera(s) (303, 304) are provided for sensing the laser light plane and interruptions thereto. Cameras (303, 304) may be provided as part of laser light plane generating module(s) (306). An additional camera (305) is also provided for detecting gestures and gross tracking of a user's body parts as herein described.

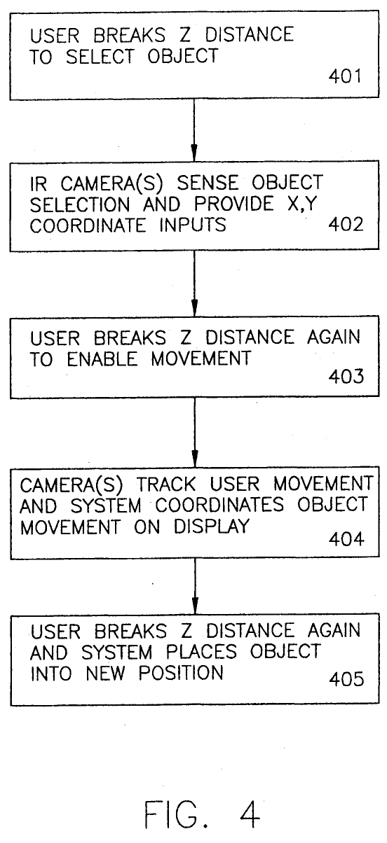

FIG. 4 is a flow chart of the selection and movement of an object according to an embodiment of the instant invention. The user first selects an object by touching the display screen (or nearly touching the display screen), breaking the plane of laser light located a Z distance away from the surface and/or screen (401). The system senses this selection of an object (402) for movement via the IR cameras (303, 304) provided e.g. on the display case of the device and X, Y coordinates of the object's position are ascertained. The object thus selected may be highlighted, etc, to indicate selection for movement. Thereafter, the user once again breaks the plane of laser light located a Z distance away from the surface and/or screen to enable movement of the object about with respect to the screen (403). As the user moves his or her hand away from the screen farther than the IR plane (i.e. picks up the object), camera (305) will be utilized to track the movements of the user's hand (e.g. via gesture tracking) and enable the user to view the moving object accordingly. Thus, the system then shows the user, upon the display, the selected object's movement corresponding to the user's (finger/hand) movements (404). Upon the user touching the screen again (405) (thereby breaking the IR plane located at the Z distance), the system places (i.e. “drops”) the object into its new location, corresponding to the place (X, Y coordinates) where the user has again broken the IR plane, as sensed by the IR cameras (303, 304).

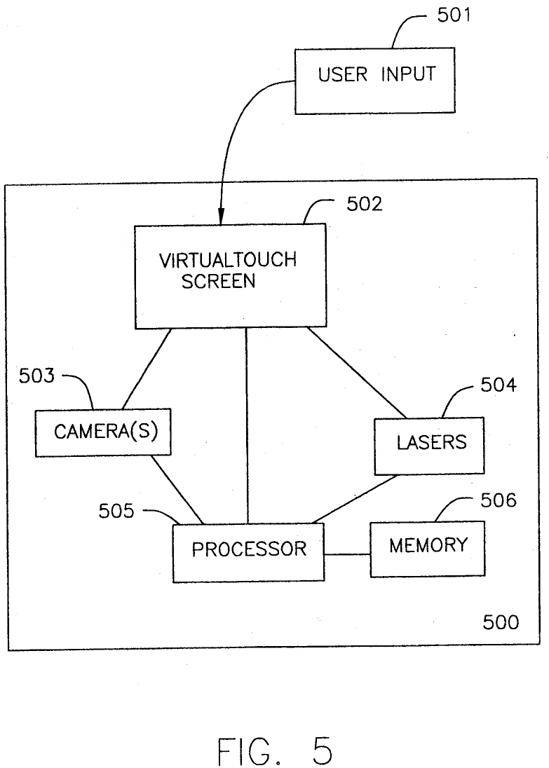

FIG. 5 is a block diagram of a computing device (500) according to one embodiment of the invention. A user input (501) is made with, e.g. a finger or a stylus, onto a virtual touch screen area of the device (502). The virtual touch screen area of the device provides IR reflection (from IR laser light source (504)) inputs to the camera(s) (503). The inputs from the cameras are provided to the device's processor (505), which is in communication with a system memory (506), for processing.

According to one embodiment of the invention, the virtual touch screen system is adapted to be positioned onto a display screen of an electronic device (e.g. a computer display screen) as depicted in FIG. 3. According to one embodiment, the invention can be adapted to accommodate computing systems wherein multiple display screens are utilized simultaneously.

According to one embodiment of the instant invention, whatever a user touches is the object that the user is moving (picking up or dropping). For example, if the user touches the top of an application window (e.g. the bar at the top of an Internet browser window that is traditionally used for moving it with a mouse) by breaking the plane of laser light, the application window can be moved. The selection of the object (e.g. Internet browser window) allows the system to relate the movement of the user's hand/fingertip with the movement of the object about the screen.

In practical effect, the system accomplishes functionality similar to using a mouse. That is, whatever a user can move with a mouse pointer (inputs) can be moved with the inventive system. However, instead of using the mouse pointer and mouse buttons as inputs, the inventive system enables “touching” or selecting by breaking the plane of laser light above the screen to be used as inputs, without relying on capacitive/resistive technology, the traditional mouse clicks or the like.

After selection, the user again breaks the plane of laser light and lifts the object up by moving the hand away from the screen (which movement away is tracked by the additional camera, the additional camera providing additional inputs for tracking the movement and moving the displayed object). The user then moves the object about and then pushes it back down towards the screen (again breaking the plane of laser light) where the user wants the object to go. Thus, instead of using a mouse button and dragging the object, the user is enabled to touch the object with a finger, pick it up, and touch it down where the user wants it to go.

Preferably, the inventive system utilizes the IR cameras for fine positioning; however, according to one embodiment of the instant invention, the IR cameras may be used for doing all of the positioning of the objects, fine and gross. This involves a different pattern of object selection. For example, the user can select an object upon breaking the laser light plane and, withdraw the hand, then place the hand back into the plane to accomplish movement. Thus, the user can maintain the hand/fingertip within the plane and move the object about (thus providing IR camera data about how the object is being moved about within the IR laser light plane as the object moves). The particular pattern chosen can enable the system to distinguish between moving the pointer/cursor on the screen and the object. Thus, the IR cameras could be used alone, without the use of the additional camera.

According to one embodiment of the instant invention, the additional camera (which need not be an IR sensitive camera) ascertains what body part broke the plane of laser light. Essentially the camera detects that a particular body part (e.g. fingertip) needs to be followed/tracked in order to relate the movement of the object upon the display. As the tracked body part (e.g. a fingertip) moves across with respect to the screen, the camera keeps track of how that fingertip is moving. So if the user fingertip breaks the plane of IR light, the tracking system determines which fingertip to follow based upon which one broke the plane initially.

There is existing software (e.g. gesture tracking software) that enables such tracking to take place and may be adapted for use with the instant invention. For example, there is existing software that enables tracking of a swipe of a user's finger across a screen. The computer system running such software is enabled to determine what the swipe means (e.g. the user wants to go to the next page of a document, etc.). Again, the camera tracks gross movements to keep track of a particular body part and tracks which way it is going, provides data inputs for the system to coordinate the movement of the selected object upon the screen.

For example, EyeGaze software keeps track of where a user is looking to move a mouse accordingly. Other examples of similar software include at least facial recognition software that maps where a user's eyes, nose, mouth, etc., are and actually provides a picture on the screen so the user can see what movements they are doing. Any suitable type of tracking software may be adapted to handle the inputs from the inventive system's cameras.

In brief recapitulation, according to at least one embodiment of the instant invention, systems and methods are provided to enable a user to select, move and drop an object appearing on the display screen of an electronic apparatus in a move intuitive and user friendly way. The inventive systems and methods provide a novel user interface for accomplishing the intuitive movement of objects about the display screen.

Those having ordinary skill in the art will readily understand that the inventive system, in addition to the cameras and lasers light producing modules, can be implemented in tangible computer program products or modules. Thus, at least part of the inventive system can be implemented in an Operating System (OS) or in a driver, similar to the way in which traditional mouse enabled movements are currently supported.

If not otherwise stated herein, it is to be assumed that all patents, patent applications, patent publications and other publications (including web-based publications) mentioned and cited herein are hereby fully incorporated by reference herein as if set forth in their entirety herein.

Many of the functional characteristics of the inventive system described in this specification may be implemented as modules. Modules may include hardware circuits such as one or more processors with memory, programmable logic, and/or discrete components. The hardware circuits may perform hardwired logic functions, execute computer readable programs stored on tangible storage devices, and/or execute programmed functions. The computer readable programs may in combination with a computer system and the other described elements perform the functions of the invention.

It is to be understood that elements of the instant invention, relating to particular embodiments, may take the form of entirely hardware embodiment or an embodiment containing both hardware and software elements. An embodiment that is implemented in software may include, but is not limited to, firmware, resident software, etc.

Furthermore, embodiments may take the form of a computer program product accessible from a computer-usable or computer-readable medium providing program code for use by or in connection with a computer or any instruction execution system.

The computer readable medium can be an electronic, magnetic, optical, electromagnetic, etc. medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers as known in the art.

Network adapters may also be coupled to the system to enable the data processing system to become coupled to other data processing systems or remote printers or storage devices through intervening private or public networks. Modems, cable modems and Ethernet cards are just a few of the currently available types of network adapters.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated. The Abstract, as submitted herewith, shall not be construed as being limiting upon the appended claims.

What is claimed is:

1. An apparatus comprising:
a user interface comprising:
at least one infrared light generating module; and
at least one camera that provides inputs upon detecting interruptions of the infrared light;
at least one processor;
at least one display medium; and
a memory, wherein the memory stores instructions executable by the at least one processor, the instructions comprising:
instructions for selecting an object rendered upon the at least one display medium in response to a first input from the at least one camera;
instructions for permitting movement of the selected object in response to a second input from the at least one camera; and
instructions for placing the selected object into a new position in response to a third input from the at least one camera.

2. The apparatus according to claim 1, wherein the user interface further comprises:
another camera that enables gross tracking of a movement of a body part of a user with respect to the user interface.

3. The apparatus according to claim 1, wherein the at least one camera ascertains X, Y coordinates of the interruption of the laser light by directly measuring finger reflection.

4. The apparatus according to claim 2, wherein the instructions further comprise:
instructions for coordinating body part movement, as detected by the another camera, and a movement of the selected object.

5. The apparatus according to claim 1, wherein the instructions further comprise:
instructions coordinating body part movement, as detected by the at least one camera, and a movement of the selected object.

6. The apparatus according to claim 4, wherein the instructions further comprise:
instructions for moving a cursor upon the at least one display medium.

7. The apparatus according to claim 1, wherein the at least one display medium comprises:
a liquid crystal display.

8. The apparatus according to claim 1, wherein the at least one display medium comprises at least two monitors.

9. The apparatus according to claim 1, wherein the at least one camera ascertains X, Y coordinates of the interruption of the laser light by directly measuring finger reflection without a reflective rim.

10. A method comprising:
generating a plane of infrared light about a user interface;
providing inputs upon detecting interruptions of the plane of laser light with at least one camera;
selecting an object rendered upon at least one display medium in response to a first input from the at least one camera;
permitting movement of the selected object in response to a second input from the at least one camera; and
placing the selected object into a new position in response to a third input from the at least one camera.

11. The method according to claim 10, further comprising:
providing another camera to enable gross tracking of a movement of a body part of a user with respect to the user interface.

12. The method according to claim 10, wherein the at least one camera ascertains X, Y coordinates of the interruption of the infrared light by directly measuring finger reflection.

13. The method according to claim 11, further comprising:
coordinating body part movement, as detected by the another camera, and a movement of the selected object.

14. The method according to claim 10, further comprising:
coordinating body part movement, as detected by the at least one camera, and a movement of the selected object.

15. The method according to claim 10, further comprising:
enabling coordination of a movement of a body part of a user and a movement of the object rendered upon the at least one display medium.

16. The method according to claim 13, further comprising:
moving a cursor upon the at least one display medium.

17. The method according to claim 10, wherein the at least one display medium is a liquid crystal display.

18. The method according to claim 10, wherein the at least one display medium comprises at least two monitors.

19. The method according to claim 10, wherein the at least one camera ascertains X, Y coordinates of the interruption of the laser light by directly measuring finger reflection without a reflective rim.

20. A program storage device readable by machine, tangibly embodying a program of instructions executable by the machine to perform a method, the method comprising:
generating a plane of infrared light about a user interface;
providing inputs upon detecting interruptions of the plane of laser light with at least one camera;
selecting an object rendered upon at least one display medium in response to a first input from the at least one camera;
permitting movement of the selected object in response to a second input from the at least one camera; and
placing the selected object into a new position in response to a third input from the at least one camera.
